(19) United States
(12) Patent Application Publication
(10) Pub. No.: US 2002/0181400 A1
(43) Pub. Date: Dec. 5, 2002

(54) Method of communicating a flow of data packets across a network

(75) Inventors: Haihong Zheng, Coppell, TX (US); Franck Le, Irving, TX (US); Stefano M. Faccin, Dallas, TX (US)

Correspondence Address: ALTERA LAW GROUP, LLC, 6500 CITY WEST PARKWAY, SUITE 100, MINNEAPOLIS, MN, 55344-7704, US

(73) Assignee: Nokia Corporation, Espoo (FI)

(21) Appl. No.: 09/870,141

(22) Filed: May 30, 2001

(51) Int. Cl. H04L 12/26; H04L 12/56

(52) U.S. Cl. 370/235; 370/352; 370/389

(57) ABSTRACT

A method of communicating a flow of data packets across a network, said network comprising routing means including communication nodes and communication endpoints, wherein a data packet is structured to have a plurality of fields including header fields and payload fields and such a data packet is communicated from endpoint to endpoint via at least one node; the method comprising the steps of generating (S31) a flow identity number for said flow by an originating endpoint of said flow; writing (S32), by said originating endpoint, at least a source address of said flow and a destination address of said flow into header fields of each of data packets belonging to said flow; writing (S32) said flow identity number into a header field of each data packet belonging to said flow which is examined by every routing means along the communication path of said flow, but remains unchanged during the whole communication; and examining (S33) the header fields containing said flow identity number, said source address and said destination address by every (S36) routing means along the communication path of said flow, wherein said flow is uniquely identified by the flow identity number being unique itself, or by combination of said source address and said flow identity number, or by combination of said source address and said destination address and said flow identity number.

### FIELD OF THE INVENTION

The present invention relates to a method of communicating a flow of data packets across a network.

### BACKGROUND OF THE INVENTION

With the present version 6 of the Internet Protocol (IPv6) being in progress, several issues concerning the security of data communicated across the Internet (IP) are under discussion or even already standardized.

Specifically, the IP security (IPSEC) working group in the Internet Engineering Task Force (IETF) specified a set of protocol mechanisms to provide for the IP level security.

In detail, these IPSEC protocols according to the document Request for Comments 2401 support packet level authentication as well as integrity and confidentiality. They are implemented by adding a new header between a packet's IP header and the transport (e.g., UDP) protocol header. A first new security header, the Authentication header (AH), is proposed and specified in document RFC2402 of the IETF, while another new security header is the Encapsulation Security Payload (ESP) which is proposed and specified in document RFC 2406.

As further development, a resource reservation protocol (RSVP) is specified in document RFC 2205. RSVP provides a receiver-initiated setup of resource reservations for multicast or unicast data flows, with good scaling and robustness properties.

Further, specification RFC 2205 tailors RSVP towards IP packets carrying protocols that have TCP- or UDP-like ports. Protocols that do not have such UDP-TCP-like ports as well as protocols whose ports are not in their expected location (which may be the case with ESP packets, where the real source and destination ports are encrypted) can be supported, but only with limitations.

Encapsulation Security Payload (ESP) according to RFC 2406 in particularly can only be supported in combination with RSVP, per IP address basis, but neither per protocol nor per flow basis, since the UDP-TCP-port like, which are usually used to identify the flow together with the source IP address, are encrypted.

Hence, there have been made several attempts to overcome this problem. The three known solutions are:

1. To use the IPSEC security parameter index (SPI) together with the IP address to identify a flow.

2. To add a new header into the IP packets.

3. To use a flow label to identify a flow.

However, all of these approaches have some big disadvantages as will be apparent from the following.

According to the first approach, a set of RSVP extensions for IPSEC data flows is specified in document RFC 2207. It extends RSVP according to RFC 2205 to use IPSEC Security Parameter index (SPI) in place of UDP/TCP-like ports.

However, if different types of flows (e.g., Voice over IP call, streaming, telnet, file transfer protocol, etc.) between two endpoints share the same security association which is identified by SPI, they will share the same reservation and cannot obtain differentiated services. This limitation exists, because IPSEC transport headers do not contain a destination demultiplexing value like UDP/TCP destination port.

According to the second approach, a further proposal according to document RFC 2207 is an option to carry a FlowID header inside an IP packet. The FlowID header contains the source and destination port number, protocol ID, etc.

The advantage of this option is that flow identification is separated from all other protocol processing.

However, the severe disadvantage is that the addition of a new header violates RFC 2402 and 2406. In addition, the source and destination port number is visible to all the routers, which lowers the advantage of using ESP.

According to the third approach, the specification of IPv6 itself includes the provision of a 20-bit field in the IPv6 header (see FIG. 1). This so-called Flow Label field has been designed to be used by a source to label sequences of packets for which the source requests special handling by the IPv6 routers, such as non-default quality of service (QoS) or “real-time” service. A flow is uniquely identified by the combination of a source address and a non-zero flow label.

However, while RSVP assumes that the field is kept untouched until the packet reaches the final destination and it uses this field to perform the packet classification, it is not defined in the IPv6 specification, whether the field can be rewritten by intermediate routers or the field should be kept untouched. Rather, it was to let future QoS protocols to make the choice.

Moreover, the IETF Mobile IP (MIP) working group specified a set of protocols to support IP mobility. With MIP protocol, an endpoint changes its IP address when it changes its access point.

However, MIP didn't specify whether the flow label field needs to be changed when the source IP address needs to be changed.

Due to the uncertainty of the usage of the flow label field, a new mechanism to identify a flow is strongly on demand.

### SUMMARY OF THE INVENTION

Therefore, it is the object of the present invention to provide a new scheme to identify a flow which is free from the above drawbacks.

According to the present invention, this object is solved by a method of communicating a flow of data packets across a network, said network comprising routing means including communication nodes and communication endpoints, wherein a data packet is structured to have a plurality of fields including header fields and payload fields and such a data packet is communicated from endpoint to endpoint via at least one node; the method comprising the steps of generating a flow identity number for said flow by an originating endpoint of said flow; writing, by said originating endpoint, at least a source address of said flow and a destination address of said flow into header fields of each of data packets belonging to said flow; writing said flow identity number into a header field of each data packet belonging to said flow which is examined by every routing means along the communication path of said flow, but remains unchanged during the whole communication; and examining the header fields containing said flow identity number, said source address and said destination address by every routing means along the communication path of said flow, wherein said flow is uniquely identified by the flow identity number being unique itself, or by combination of said source address and said flow identity number, or by combination of said source address and said destination address and said flow identity number.

With this method of communicating a flow of data packets across a network, an important prerequisite for a flawless data flow processing is fulfilled. That is, according to the method of the present invention, the uniqueness of the identifying combination is secured.

Apart from that, according to the present invention it is further possible to identify a flow, i.e. to recognize that certain data packets belong together.

To achieve this, further steps of recognizing by said routing means that data packets belong together by identifying a flow thereof by means of the flow identity number itself, or by combination of said source address and said flow identity number, or by combination of said source address and said destination address and said flow identity number; and processing said flow by said routing means are added to the method according to the present invention.

The present invention will become more apparent from the following detailed description of the preferred embodiments when taken in conjunction with the accompanying drawings.

### BRIEF DESCRIPTION OF THE DRAWINGS

FIG. 1 shows the structure of a data packet according to version 6 of the Internet Protocol as specified in RFC 2460.

FIG. 2 shows the structure of a data packet where the Hlop-By-Hop Options header according to IPv6 is used.

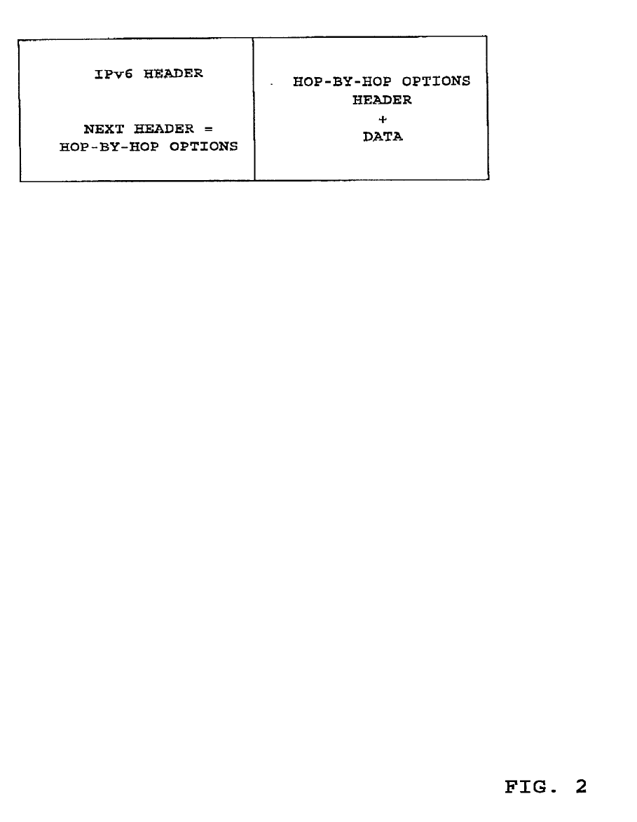

FIG. 3 shows a flow-chart depicting the method according to the present invention as well as an advantageous extension thereof.

### DESCRIPTION OF THE PREFERRED EMBODIMENTS

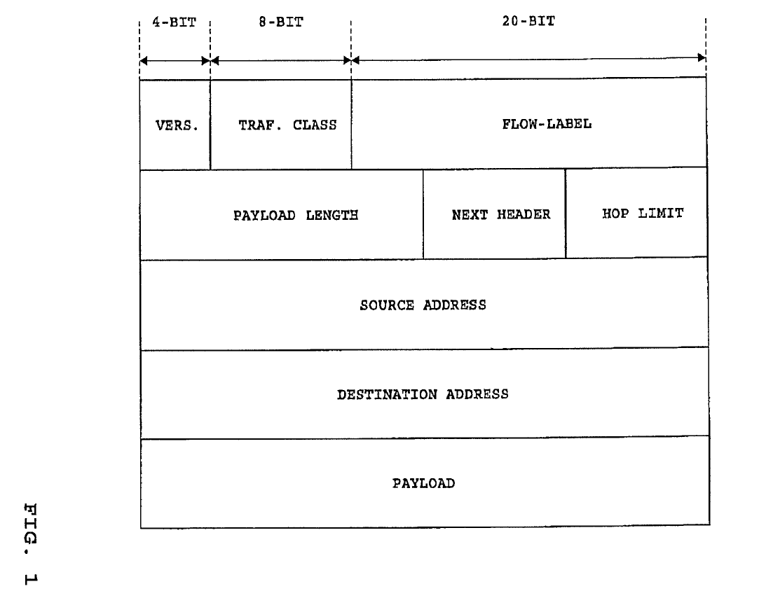

The present invention is preferably embedded within the IPv6. A data packet according to IPv6 is shown in FIG. 1. Such a data packet comprises several fields with the data packet having an overall width of 32 Bit. As mentioned before, IPv6 is specified in document RFC 2460.

Accordingly, a data packet consists of header fields and the payload.

Specifically, the 4-Bit version field provides the version of the data packet, i.e. 6. Next, the Traffic Class field is provided for differentiating between classes/priorities of data packets. This field is 8 Bit in width.

The first line is completed by the 20-Bit Flow Label field which is already described above. It is to be noted that this field is not yet fully defined which is one of the problems underlying the present invention. Anyway, this field is intended for identifying a flow. However, according to the current agreements, this field cannot provide for this issue with appropriate safety.

In the next line, fields for informing about the payload length, the kind of the next header and the hop limit are given. The intention of the payload length field should be obvious. The Next Header field will be described later on. The Hop Limit field contains a value which is decremented by 1 for every Hop. If the value reaches zero, the data packet is discarded. As a result, it is made sure that no data packets are travelling across the Internet “forever” and without destination. So to speak, the Hop Limit field provides the maximum live time of the data packet.

Finally, the IPv6 header is completed by respectively 32-Bit fields for the source address and the destination address. Thereafter, data constituting the payload is appended.

Version 6 of the IP allows to include extension headers in a data packet. These separate headers include optional internet-layer information. It may be that none or one or several of these extension headers is/are present. These headers are considered to be part of the payload and are inserted before the upper layer header of the payload. If there is an extension header in the payload is identified by the above mentioned Next Header field of the IPv6 header. The extension header itself also carries a Next Header field which in turn informs whether there is another header following or not.

In any case, there is a recommendation about the order in which the extension headers shall appear between IPv6 header and upper layer header, if respectively present. The order is

IPv6 header

Hop-By-Hop Options header

Destination Options header

Routing header

Fragment header

Authentication header

Encapsulating Security Payload header

Destination Options header

upper layer header

Of these, it is only the Hop-By-Hop Options header which must be examined by every node along a packet's delivery path, including the source and destination nodes. Contrarily, the other extension headers are only examined by the node identified in the Destination Address field of the IPv6 header. Apart form that, these other extension headers are of no particular interest for understanding the present invention. Hence, a further description thereof is omitted.

As best mode for implementing the present invention is presently considered to use the Hop-By-Hop Options header for identifying a flow. That is, a flow identity option (flow-id) is defined in the IPv6 Hop-by-Hop Options header. This flow-id option carries, among other fields, a flow-id number which is generated by the source endpoint and which is intended for uniquely identifying a flow. This can be achieved by the flow identity number itself being unique or together with other fields (e.g. source address and destination address), i.e. in combination with either the source address or the source address and the destination address. Since the Hop-by-Hop Options header carries information that must be examined and processed by every node along a packet's delivery path, all the routing means including communication nodes and communication endpoints that need the flow identification information can obtain such information from this flow-id option.

This also means that when the endpoint changes its IP address during a session, it still keeps the same flow-id for the same flow.

The flow-id option inside the Hop-By-Hop Options header can be used by a different protocol. For example, when IPSEC ESP is used together with RSVP, the transport port numbers are encrypted and cannot be used to identify a flow. The flow-id instead can substitute the port number as flow identifier together with the source address.

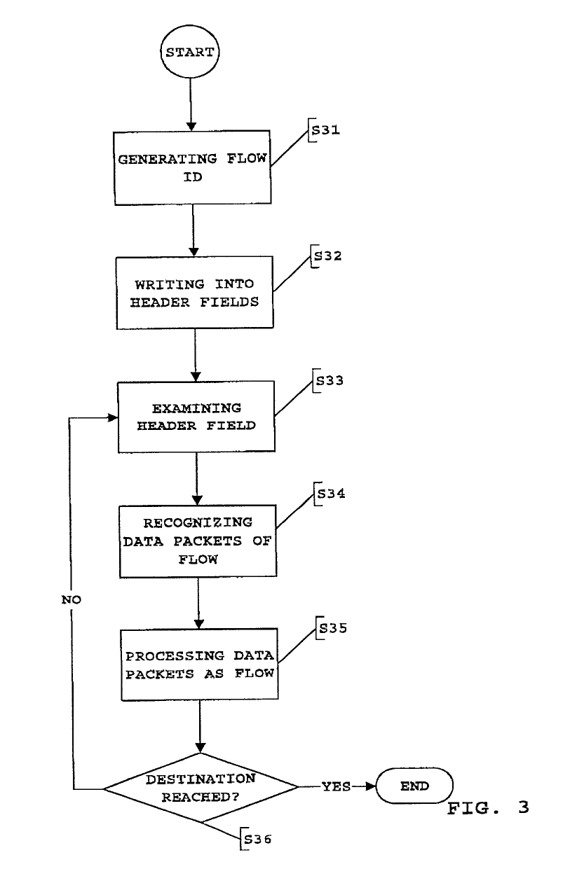

Referring now to FIG. 3, the method according to the present invention within the present embodiment comprises the following steps.

In a step S31, the source of a flow of data packets generates a flow identity number. This number has to fulfill any prerequisite which ascertains that either this flow identity number itself is unique (e.g. by a generation as a concatenation of the home IP address and a sequence number), that the flow identity number in combination with the source address is unique, or that the flow identity number in combination with the source address and the destination address is unique.

Then, as step S32, the source writes its related information into the data packet such as the flow-id number, the destination address and of course the source address.

With the step S33 of examining the fields of the Hop-By-Hop Options header by every routing means, the method according to the present invention is insofar complete as the uniqueness of the combination of at least flow-id number, source address and destination address is ascertained due to the fact that the presence of the flow-id number within a field of the Hop-By-Hop Options header guarantees that every routing means can capture the information, but it remains unchanged during the whole communication.

Hence, from the viewpoint of the data packets itself, a flawless data flow communication is ascertained.

From the viewpoint of the network and particularly the routing means thereof, it is necessary to mention that these routing means are to be adapted to recognize upon the examination step S33 that data packets belong together, thus forming a flow. This is done in a step S34. As the result of this recognition will effort to treat the data packets the same, i.e. as a flow, a corresponding processing step S35 follows. Most likely, there will be many routing means in the delivery path of a flow so that the steps S33-S35 of examining, recognizing and processing are to be executed by every routing means which however does not include any surprising effects worth to mention. This iteration shall be summarized as step S36 corresponding to a loop which is taken until the destination of the data flow is reached.

As an example of a data packet flow across the internet gaining remarkable advantages such as safety of delivery as well as compatibility to security mechanisms a Voice over IP (VoIP) call is to be mentioned.

What is described above is a method of communicating a flow of data packets across a network, said network comprising routing means including communication nodes and communication endpoints, wherein a data packet is structured to have a plurality of fields including header fields and payload fields and such a data packet is communicated from endpoint to endpoint via at least one node; the method comprising the steps of generating S31 a flow identity number for said flow by an originating endpoint of said flow; writing S32, by said originating endpoint, at least a source address of said flow and a destination address of said flow into header fields of each of data packets belonging to said flow; writing S32 said flow identity number into a header field of each data packet belonging to said flow which is examined by every routing means along the communication path of said flow, but remains unchanged during the whole communication; and examining S33 the header fields containing said flow identity number, said source address and said destination address by every S36 routing means along the communication path of said flow, wherein said flow is uniquely identified by the flow identity number being unique itself, or by combination of said source address and said flow identity number, or by combination of said source address and said destination address and said flow identity number.

As is understood from the present description by those who are skilled in the art, the present invention can be applied to many technical fields, and changes and modifications may be effected to the presently preferred embodiments without departing from the scope of the appended claims.

1. A method of communicating a flow of data packets across a network,
said network comprising routing means including communication nodes and communication endpoints, wherein a data packet is structured to have a plurality of fields including header fields and payload fields and such a data packet is communicated from endpoint to endpoint via at least one node; the method comprising the steps of
generating (S31) a flow identity number for said flow by an originating endpoint of said flow;
writing (S32), by said originating endpoint, at least a source address of said flow and a destination address of said flow into header fields of each of data packets belonging to said flow;
writing (S32) said flow identity number into a header field of each data packet belonging to said flow which is examined by every routing means along the communication path of said flow, but remains unchanged during the whole communication; and
examining (S33) the header fields containing said flow identity number, said source address and said destination address by every (S36) routing means along the communication path of said flow, wherein
said flow is uniquely identified by the flow identity number being unique itself, or by combination of said source address and said flow identity number, or by combination of said source address and said destination address and said flow identity number.

2. A method according to claim 1, further comprising the steps of
recognizing (S34) by said routing means that data packets belong together by identifying a flow thereof by means of the flow identity number itself, or by combination of said source address and said flow identity number, or by combination of said source address and said destination address and said flow identity number; and
processing (S35) said flow by said routing means.

3. A method according to claim 1 or 2, wherein the communication is done via the Internet Protocol according to version 6 thereof, so that the data packets are structured according to the document “Request for Comments 2460” of the “Internet Engineering Task Force”.

4. A method according to claim 3, wherein said header field containing said flow identity number is a flow identity option field in the Hop-By-Hop Options header.

5. A method according to claim 4, wherein said flow of data packets corresponds to a Voice over Internet Protocol call.

6. A method according to claim 1, wherein the flow identity number is generated as a concatenation of the source address and a sequence number.
